(19) United States
(12) Patent Application Publication
(10) Pub. No.: US 2013/0290406 A1
(43) Pub. Date: Oct. 31, 2013

(54) MECHANISM FOR PROVIDING A CLOUD PLATFORM FOR FACILITATING AND SUPPORTING USER-CONTROLLED DEVELOPMENT AND MANAGEMENT OF USER PRODUCTS

(71) Applicant: SALESFORCE.COM, INC., San Francisco, CA (US)

(72) Inventors: Philip Norman Calvin, San Francisco, CA (US); Sonali Agrawal, San Carlos, CA (US); Eric Dorgelo, Vancouver (CA); Shelby Hubick, Vancouver (CA)

(73) Assignee: salesforce.com, inc., San Francisco, CA (US)

(21) Appl. No.: 13/665,583

(22) Filed: Oct. 31, 2012

Related U.S. Application Data
(60) Provisional application No. 61/638,627, filed on Apr. 26, 2012.

(51) Int. Cl. H04L 29/06

(52) U.S. Cl. CPC H04L 67/42
USPC 709/203

(57) ABSTRACT

In accordance with embodiments, there are provided mechanisms and methods for providing a cloud platform for facilitating and supporting user-controlled development and maintenance of user products. In one embodiment and by way of example, a method includes developing at a product via a cloud platform facilitated by a mechanism at a first computing device, generating the product at the cloud platform, and maintaining, in real-time, the product at the cloud platform via the mechanism at the first computing device.

### CLAIM OF PRIORITY

This application claims the benefit of U.S. Provisional Patent Application No. 61/638,627, entitled “Methods and Systems for Providing a Site Development Platform” by Philip Normal Calvin, et al., filed Apr. 26, 2012 (Attorney Docket No.: 8956P101Z), the entire contents of which are incorporated herein by reference and priority is claimed thereof.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

One or more implementations relate generally to data management and, more specifically, to a mechanism for providing a cloud platform for facilitating and supporting user-controlled development and management of user products.

### BACKGROUND

In the growing world of computing technology, business and other organizations have to depend on having expensive hardware and employing highly-skilled computer programmers or system administrators to develop and maintain their websites, business applications, databases, etc. Such commitments are cost-inefficient as it is expensive to have such hardware and/or a team of highly-skilled computer programmers and further, such structures often encounter complex challenges if, for example, there is a problem with the hardware and/or one or more computer programmers leave their company.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches.

In conventional database systems, users access their data resources in one logical database. A user of such a conventional system typically retrieves data from and stores data on the system using the user's own systems. A user system might remotely access one of a plurality of server systems that might in turn access the database system. Data retrieval from the system might include the issuance of a query from the user system to the database system. The database system might process the request for information received in the query and send to the user system information relevant to the request. The secure and efficient retrieval of accurate information and subsequent delivery of this information to the user system has been and continues to be a goal of administrators of database systems. Unfortunately, conventional database approaches are associated with various limitations.

### BRIEF DESCRIPTION OF THE DRAWINGS

In the following drawings like reference numbers are used to refer to like elements. Although the following figures depict various examples, one or more implementations are not limited to the examples depicted in the figures.

FIG. 1 illustrates a computing device employing a mechanism for providing a cloud platform for facilitating and supporting user-controlled development and management according to one embodiment;

FIG. 2 illustrates a mechanism for providing a cloud platform for facilitating and supporting user-controlled development and management according to one embodiment;

FIG. 3 illustrates a transaction sequence for developing and maintaining customer products using a user-controlled cloud platform according to one embodiment;

FIG. 4 illustrates a method for developing and maintaining customer products using a user-controlled cloud platform according to one embodiment;

FIG. 5 illustrates a computer system according to one embodiment;

FIG. 6 illustrates a block diagram of an environment wherein an on-demand database service might be used according to one embodiment; and

FIG. 7 illustrates a block diagram of an embodiment of elements of environment of FIG. 6 and various possible interconnections between these elements according to one embodiment.

### DETAILED DESCRIPTION

Methods and systems are provided for providing a cloud platform for facilitating and supporting user-controlled development and maintenance of user products. In one embodiment and by way of example, a method includes developing at a product via a cloud platform facilitated by a mechanism at a first computing device, generating the product at the cloud platform, and maintaining, in real-time, the product at the cloud platform via the mechanism at the first computing device.

Embodiments provide a mechanism to provide a cloud platform that may be access by users (e.g., organizations, business, companies, government agencies, non-profit organizations, educational institutions, etc.) to develop and manage their own websites (e.g., business websites, etc.), software applications (e.g., business applications, etc.), and databases, etc., without having to have expensive and complicated hardware and/or software and/or employing highly-skilled personnel, such as computer programmers, system administrators, etc.

As used herein, a term multi-tenant database system refers to those systems in which various elements of hardware and software of the database system may be shared by one or more customers. For example, a given application server may simultaneously process requests for a great number of customers, and a given database table may store rows for a potentially much greater number of customers. As used herein, the term query plan refers to a set of steps used to access information in a database system.

Embodiments are described with reference to an embodiment in which techniques for facilitating management of data in an on-demand services environment are implemented in a system having an application server providing a front end for an on-demand database service capable of supporting multiple tenants, embodiments are not limited to multi-tenant databases nor deployment on application servers. Embodiments may be practiced using other database architectures, i.e., ORACLE®, DB2® by IBM and the like without departing from the scope of the embodiments claimed.

Next, mechanisms and methods for providing a cloud platform for facilitating and supporting user-controlled development and maintenance of user products.

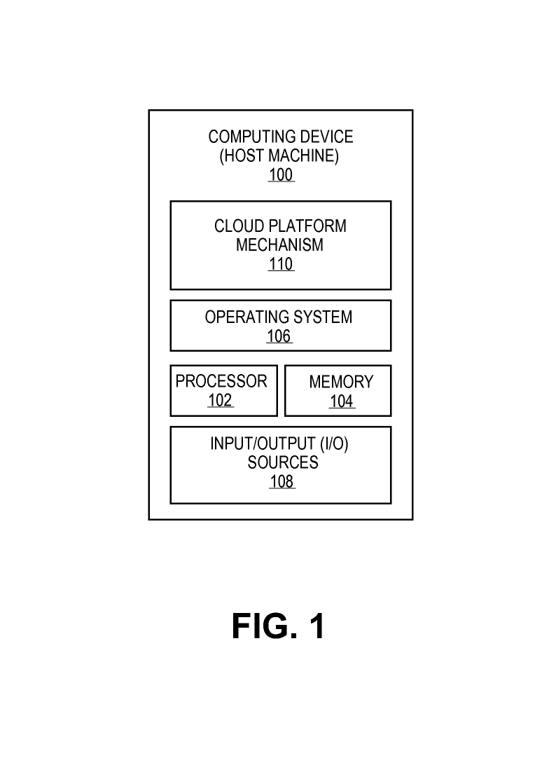

FIG. 1 illustrates a computing device 100 employing a mechanism for providing a cloud platform for facilitating and supporting user-controlled development and management (“cloud platform mechanism”) 110 according to one embodiment. In one embodiment, computing device 100 serves as a host machine employing cloud platform mechanism 110 for providing a cloud platform for facilitating and supporting user-controlled development and management as will be described further in this document.

Computing device 100 may include server computers (e.g., cloud server computers, etc.), desktop computers, cluster-based computers, set-top boxes (e.g., Internet-based cable television set-top boxes, etc.), and the like. Computing device 100 may also include smaller computers, such as mobile computing devices, such as cellular phones including smartphones (e.g., iPhone® by Apple®, BlackBerry® by Research in Motion®, etc.), handheld computing devices, personal digital assistants (PDAs), etc., tablet computers (e.g., iPad® by Apple®, Galaxy® by Samsung®, etc.), laptop computers (e.g., notebooks, netbooks, Ultrabook™, etc.), e-readers (e.g., Kindle® by Amazon.com®, Nook® by Barnes and Nobles®, etc.), Global Positioning System (GPS)-based navigation systems, etc.

Computing device 100 includes an operating system (OS) 106 serving as an interface between any hardware or physical resources of the computing device 100 and a user. Computing device 100 further includes one or more processors 102, memory devices 104, network devices, drivers, or the like, as well as input/output (I/O) sources 108, such as touchscreens, touch panels, touch pads, virtual or regular keyboards, virtual or regular mice, etc. It is to be noted that terms like “node”, “computing node”, “client”, “client device”, “server”, “server device”, “cloud computer”, “cloud server”, “cloud server computer”, “machine”, “host machine”, “device”, “computing device”, “computer”, “computing system”, “multi-tenant on-demand data system”, and the like, may be used interchangeably throughout this document. It is to be further noted that terms like “application”, “software application”, “program”, “software program”, “package”, and “software package” may be used interchangeably throughout this document.

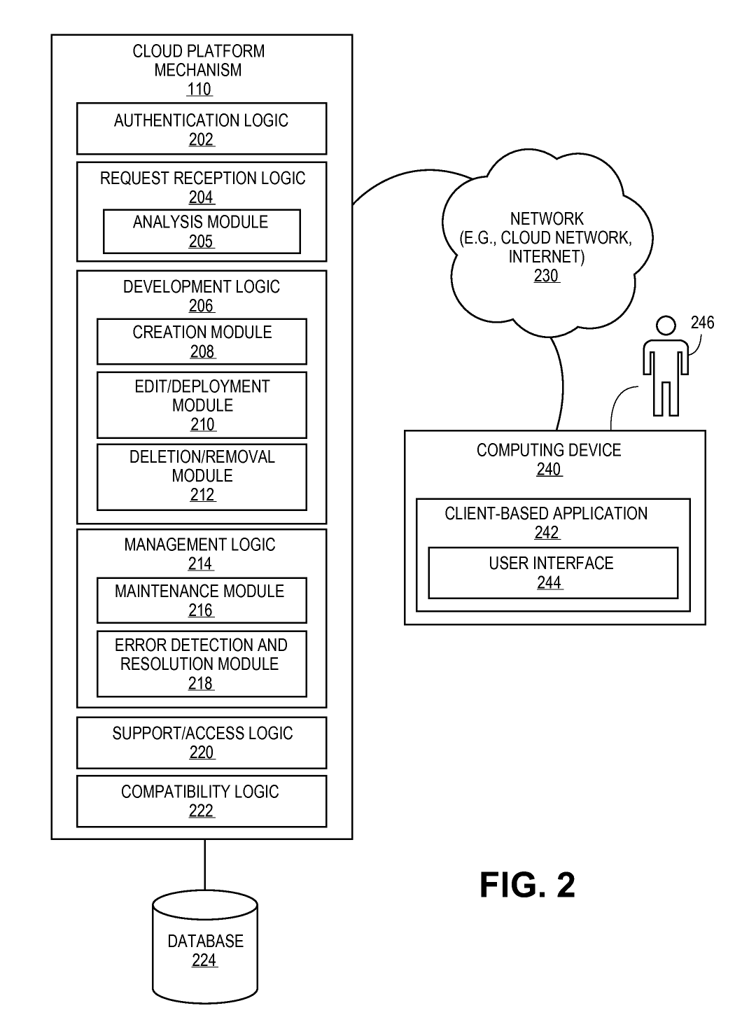

FIG. 2 illustrates a mechanism for providing a cloud platform for facilitating and supporting user-controlled development and management 110 according to one embodiment. In one embodiment, cloud platform mechanism 110 provides various tools and techniques to further modernize cross-site sharing concepts of Salesforce.com® by, for example, allowing user-controlled development and management of websites (e.g., business websites, customer websites, etc.), applications (e.g., business software applications, such as human resources (HR) application, sales application, etc.), business database, etc.

In one embodiment, cloud platform mechanism 110 may be employed at a server computing system, such as computing device 100 of FIG. 1, in communication with any number and type of computing devices serving as client computing devices, such as computing device 240 employing a client-based application 242 having a user interface 244 providing user access to user 246 (e.g., a representative of an organization that is a customer of a service provider (such as Salesforce.com) that further provides a cloud platform to user 246 via cloud platform mechanism 110, employed at the service provider's server computing device, over network 230 (such as a cloud computing network, the Internet, etc.). Similarly, it is contemplated that a user may include other users, such as an individual or a small business, etc., that is a customer of an organization/organizational customer that is represented here by user 246. It is to be noted that terms like “user”, “customer”, “organization”, “business”, “company”, etc., may be used interchangeably throughout this document. Client computing devices 240 may be the same as or similar to computing device 100 of FIG. 1 and include smaller computers, such as a mobile computing device (e.g., smartphones, tablet computers, etc.) or larger computers (such as a desktop computer, a server computer, etc.).

In the illustrated embodiment, cloud platform mechanism 110 includes various components, such as authentication logic 202, request reception logic 204 (having analysis module 205), development logic 206 (including creation module 208, editing/deployment module 210, deletion/removal module 212), management logic 214 (including maintenance logic 216, problem detection/correction module 218), support/access logic 220, and compatibility logic 222. Cloud platform mechanism 110 is in communication with database 224 and further in communication with client computing device 240, over network 230, employing client-based application 242 providing user interface 244. Throughout this document, the term “logic” may be interchangeably referred to as “component” or “module” and may include, by way of example, software, hardware, and/or any combination of software and hardware, such as firmware.

In one embodiment, user 246 may access, via user interface 244 and client-based application 242, a cloud platform provided by cloud platform mechanism 110. As will be further described later, providing access to the cloud platform includes providing any number and type of development and management tools that may access and used by user 246, via client-based application 242, for development and management purposes.

In one embodiment, access to cloud platform facilitated by cloud platform mechanism 110 facilitates, via development logic 206 (and its components 208-210), management logic (and its components maintenance module 216, error detection and resolution module 218), and other components 202, 204, 205, 220, 222), for user 246 a development platform as well as a cloud infrastructure for development and maintenance of various products (e.g., websites (e.g., a business/customer website), applications (e.g., a business/customer software application), databases, user interfaces (UIs), etc.) by providing a range of development and infrastructure tools, such as integrated libraries, real-time analysis, programming logic (e.g., cloud programming logic), databases, integrated applications, sophisticated/complex codes (e.g., integrated development environment (IDE), UI framework, development and testing tools, etc.), real-time updates, real-time analysis, mobile backups, real-time security, performance checks and real-time testing tools, recovery and backup tools, maintenance services, scalability, developmental environment, etc. In one embodiment, cloud platform mechanism 110 facilitates such development and maintenance tools and facilities to user 246 via client-based application 242 at client device 240 without having to requiring user 246 to employ any expensive hardware/software and/or employ highly-skilled programmers, administrators, etc.

Authentication logic 202 may be used to authenticate user 246, their organization, and/or their computing device 220 before they are allowed the authority to perform the processes of development and management. It is contemplated that, in some embodiments, the authentication process may be a one-time process conducted when an organization, represented as user 246, is registered to received services provided by cloud platform mechanism 110 or downloads client-based application 242 on their computing device 240 and/or when computing device 240 is first allowed to access cloud platform mechanism 110 via user interface 244 of client-based application 242. In other embodiments, authentication may be a recurring process to be performed each time a development and/or management-related task is requested (via client-based application 242 and further via user interface 244) and received by request reception logic 204 at cloud platform mechanism 110 employed at the cloud-based server computer over network 230.

In one embodiment, a request for development of a product at the cloud platform may be received at request reception logic 204 at cloud platform mechanism 110. For example, when user 246 attempts to develop a product via client-based application 242 at computing device, this attempt may get translated into a request and then communicated on to cloud platform mechanism 110 which may then be authenticated by authentication logic 202 and preliminarily analyzed by analysis module 205. For example, the request may be analyzed to determine which tool or facility may it be assigned to accomplish the task, such as if a product is to be created from scratch, the request may be assigned to creation module 208 which provides a number and type of product creation tools (e.g., programming code, prepared templates, access to libraries at database 224, pre-creation testing tools, etc.) may be used.

Similarly, if edits are proposed to an already existing product (e.g., amending content or format of a business website, adding new features or providing an update to a business software application, etc.), the request may be analyzed and forwarded on to edit/deployment module for processing where the product is edited, as requested, and redeployed to be used again. Any attempt to delete or remove a product is translated into a request for deletion and is processed by deletion/remove module 212 that deletes the product per the request.

Once a product is developed it is continuously managed, via management logic 214, to make sure that the product remains trouble-free and continues to serve its purpose. Management logic 214, in one embodiment, provides the necessary tools for management of the developed product, such as maintenance-related tools for ensuring the product's performance, security, recovery/backup, scalability, environmental upgrades, etc., as well as testing and troubleshooting tools for making sure the product is continuously tested and remains error-free and that if the product does encounter one or more errors/problems, such errors/problems are troubleshot and resolved in a timely and efficient manner. In the illustrated embodiment, for brevity and ease of understanding, maintenance logic 214 includes maintenance module 216 encompassing maintenance tools and error detection and resolution module 218 providing troubleshooting and error-correction tools.

Cloud platform mechanism 110 further includes support/access logic 220 to provide support for developed products as well as access to database 224 for anything (such as ranging from relevant data to applicable code to additional development/maintenance tools, etc.) that might of help in developing and/or maintaining user products. For example, in case of a problem with a developed product that could not be resolved through error detection and resolution module 218, support/access logic 220 may refer/signal the problem to a team of experts (e.g., computer programmers, system administrators, etc.) employed by the service provider (such as Salesforce.com who provides cloud platform mechanism 110 and maintains the cloud server computer that employs it) to troubleshoot, analyze and fix the problem on behalf of user 246. Stated differently, even when encountering a problem that is directly resolved by error detection and resolution module 218, the problem is referred to the service provider, without having user 246 to employ expensive hardware/software and/or highly-skilled technical staff. Compatibility logic 222 allows for mapping and synchronization mechanism 110 to maintain compatibility with any number and types of sites, computing devices 220, networks 230, or the like.

It is contemplated that any number and type of components may be added to and/or removed from cloud platform mechanism 110 to facilitate various embodiments including adding, removing, and/or enhancing certain features. For brevity, clarity, and ease of understanding of cloud platform mechanism 110, many of the standard and/or known components, such as those of a computing device, are not shown or discussed here. It is contemplated that embodiments are not limited to any particular technology, topology, system, architecture, and/or standard and are dynamic enough to adopt and adapt to any future changes.

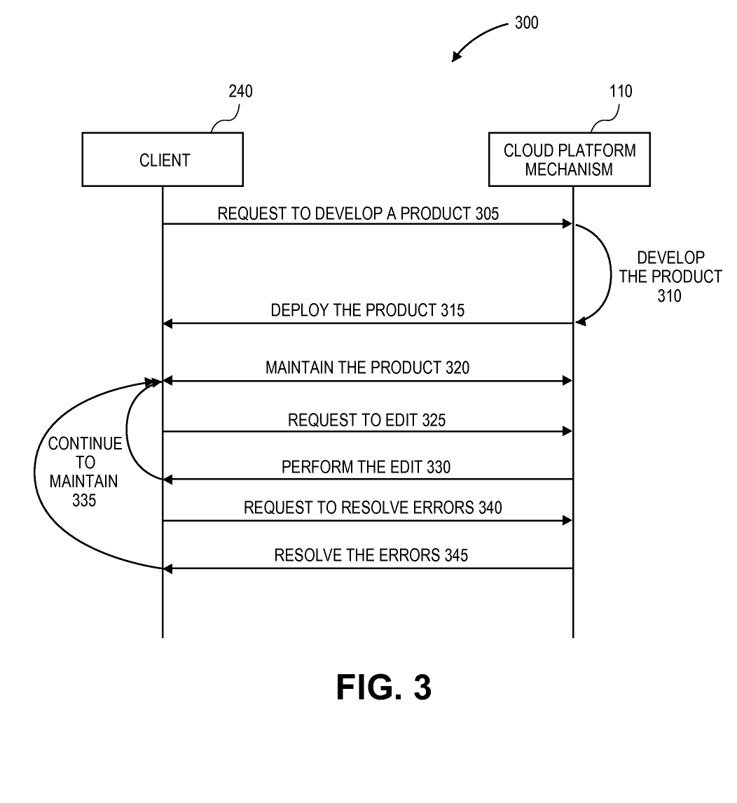

FIG. 3 illustrates a transaction sequence 300 for developing and maintaining customer products using a user-controlled cloud platform according to one embodiment. Transaction sequence 300 may be performed by processing logic that may comprise hardware (e.g., circuitry, dedicated logic, programmable logic, etc.), software (such as instructions run on a processing device), or a combination thereof. In one embodiment, method 300 may be performed by cloud platform mechanism 110 of FIG. 1.

For brevity, clarity and ease of understanding, some of the components and processes described above with respect to FIGS. 1-2 are not described here. In the illustrated embodiment, a request for developing a product (e.g., a customer website, a business software application, a database, etc.) is initiated by a customer/user at a client computing device 240 and received 305 at cloud platform mechanism 110 over a network, such as a cloud network. A cloud platform as facilitated by cloud platform mechanism 110 is used to develop the product 310 and deployed 315 to be used by the user. Once the product is developed, it is continuously maintained at the cloud platform.

If the product is to be edited (e.g., update to a newer version, content correction, bug fixing, design/format changes, etc.), the user may make such edits using the cloud platform. Any attempt to perform the edits translates into a request to edit and is provided 325 to cloud platform mechanism 110 that facilitates performing the edits 330 via the cloud platform provided to the user via the client computing device 240. Once the edits have been made, the process continues with maintenance of the product 335.

Further, while maintaining the product, if an error/problem is detected, a request to correct the error is automatically generated and communicated on 340 to cloud platform mechanism 110. The error/problem is troubleshot and automatically resolved 345 by cloud platform mechanism 110. Once the error/problem is fixed, the process continues with maintenance of the product 335.

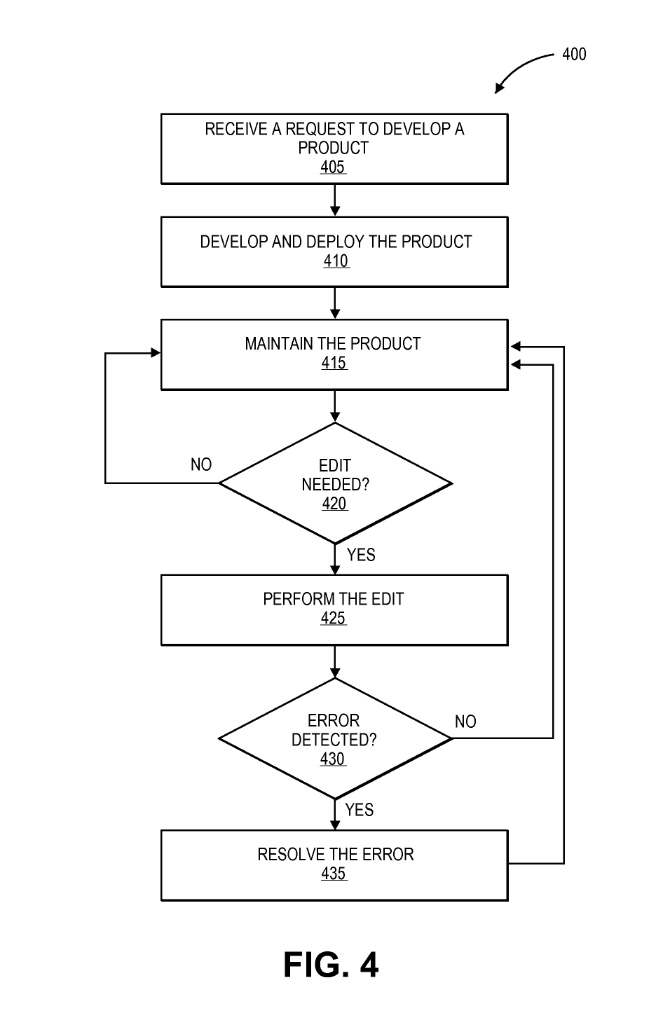

FIG. 4 illustrates a method 400 for developing and maintaining customer products using a user-controlled cloud platform according to one embodiment. Method 400 may be performed by processing logic that may comprise hardware (e.g., circuitry, dedicated logic, programmable logic, etc.), software (such as instructions run on a processing device), or a combination thereof. In one embodiment, method 300 may be performed by cloud platform mechanism 110 of FIG. 1.

For brevity, clarity and ease of understanding, some of the components and processes described above with respect to FIGS. 1-3 are not described here. In the illustrated embodiment, at block 405, a request for developing a product (e.g., a customer website, a business software application, a database, etc.) is received at cloud platform mechanism over a network, such as a cloud network. At block 410, a cloud platform as facilitated by cloud platform mechanism is used to develop the product and deployed to be used by the user. Once the product is developed, it is maintained at the cloud platform at block 415.

At block 420, a decision is made as to whether any edits are to be performed to the product (e.g., update to a newer version, content correction, bug fixing, design/format changes, etc.). If the product is to be edited, at block 425, the edits are made at the cloud platform, by the user via a client computing device, as facilitated by cloud platform mechanism. If not edits are to be made, the process continues with maintenance of the product at block 415.

Further, at decision block 430, a determination is made as to whether any errors are detected and to be resolved. If no errors are detected, the process continues with maintenance of the product at block 415. If any errors detected, they are troubleshot and automatically resolved by cloud platform mechanism at block 435 and the process continues with maintenance of the product 415.

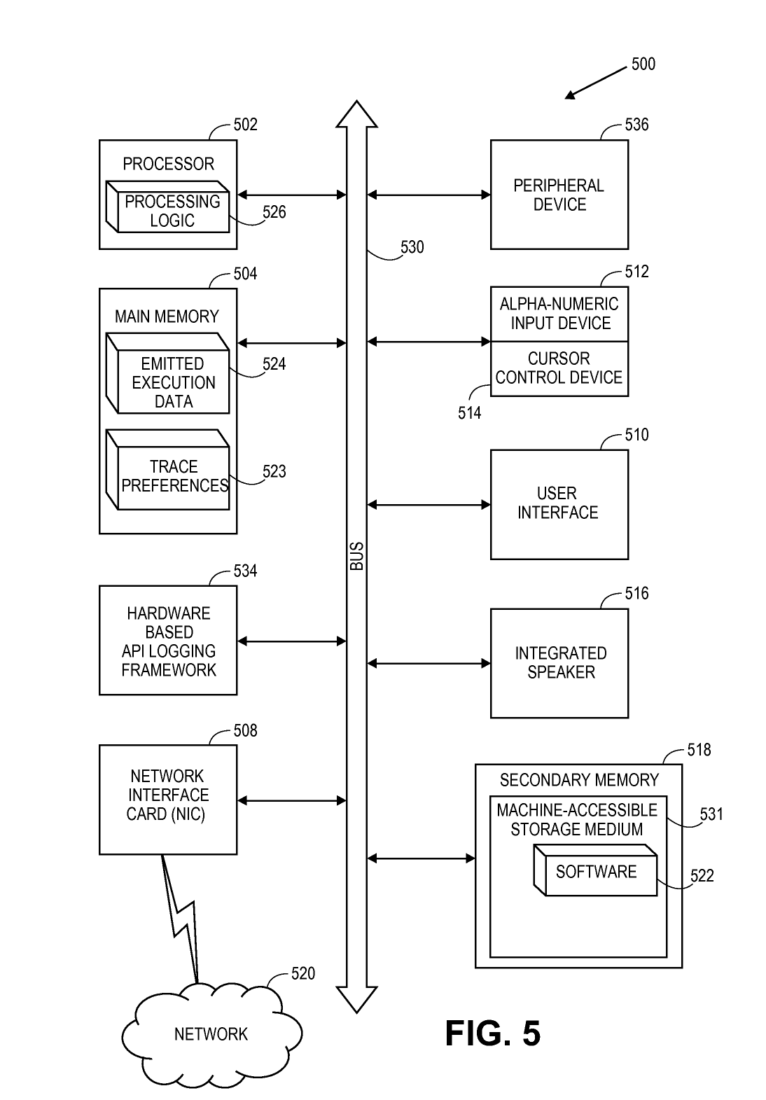

FIG. 5 illustrates a diagrammatic representation of a machine 500 in the exemplary form of a computer system, in accordance with one embodiment, within which a set of instructions, for causing the machine 500 to perform any one or more of the methodologies discussed herein, may be executed. Machine 500 is the same as or similar to computing device 100 and computing devices 230, 240 of FIG. 1 and FIG. 2, respectively. In alternative embodiments, the machine may be connected (e.g., networked) to other machines in a network (such as machine 110 of FIG. 1 connected with machines 230, 240 of FIG. 2 over network 250), such as a cloud-based network, a Local Area Network (LAN), a Wide Area Network (WAN), a Metropolitan Area Network (MAN), a Personal Area Network (PAN), an intranet, an extranet, or the Internet. The machine may operate in the capacity of a server or a client machine in a client-server network environment, or as a peer machine in a peer-to-peer (or distributed) network environment or as a server or series of servers within an on-demand service environment, including an on-demand environment providing multi-tenant database storage services. Certain embodiments of the machine may be in the form of a personal computer (PC), a tablet PC, a set-top box (STB), a Personal Digital Assistant (PDA), a cellular telephone, a web appliance, a server, a network router, switch or bridge, computing system, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 500 includes a processor 502, a main memory 504 (e.g., read-only memory (ROM), flash memory, dynamic random access memory (DRAM) such as synchronous DRAM (SDRAM) or Rambus DRAM (RDRAM), etc., static memory such as flash memory, static random access memory (SRAM), volatile but high-data rate RAM, etc.), and a secondary memory 518 (e.g., a persistent storage device including hard disk drives and persistent multi-tenant data base implementations), which communicate with each other via a bus 530. Main memory 504 includes emitted execution data 524 (e.g., data emitted by a logging framework) and one or more trace preferences 523 which operate in conjunction with processing logic 526 and processor 502 to perform the methodologies discussed herein.

Processor 502 represents one or more general-purpose processing devices such as a microprocessor, central processing unit, or the like. More particularly, the processor 502 may computing (RISC) microprocessor, very long instruction word (VLIW) microprocessor, processor implementing other instruction sets, or processors implementing a combination of instruction sets. Processor 502 may also be one or more special-purpose processing devices such as an application specific integrated circuit (ASIC), a field programmable gate array (FPGA), a digital signal processor (DSP), network processor, or the like. Processor 502 is configured to execute the processing logic 526 for performing the operations and functionality of dynamic customization mechanism 110 as described with reference to FIG. 1 and other figures discussed herein.

The computer system 500 may further include a network interface card 508. The computer system 500 also may include a user interface 510 (such as a video display unit, a liquid crystal display (LCD), or a cathode ray tube (CRT)), an alphanumeric input device 512 (e.g., a keyboard), a cursor control device 514 (e.g., a mouse), and a signal generation device 516 (e.g., an integrated speaker). The computer system 500 may further include peripheral device 536 (e.g., wireless or wired communication devices, memory devices, storage devices, audio processing devices, video processing devices, etc. The computer system 500 may further include a Hardware based API logging framework 534 capable of executing incoming requests for services and emitting execution data responsive to the fulfillment of such incoming requests.

The secondary memory 518 may include a machine-readable storage medium (or more specifically a machine-accessible storage medium) 531 on which is stored one or more sets of instructions (e.g., software 522) embodying any one or more of the methodologies or functions of dynamic customization mechanism 110 as described with reference to FIG. 1 and other figures described herein. The software 522 may also reside, completely or at least partially, within the main memory 504 and/or within the processor 502 during execution thereof by the computer system 500, the main memory 504 and the processor 502 also constituting machine-readable storage media. The software 522 may further be transmitted or received over a network 520 via the network interface card 508. The machine-readable storage medium 531 may include transitory or non-transitory machine-readable storage media.

Portions of various embodiments may be provided as a computer program product, which may include a computer-readable medium having stored thereon computer program instructions, which may be used to program a computer (or other electronic devices) to perform a process according to the embodiments. The machine-readable medium may include, but is not limited to, floppy diskettes, optical disks, compact disk read-only memory (CD-ROM), and magneto-optical disks, ROM, RAM, erasable programmable read-only memory (EPROM), electrically EPROM (EEPROM), magnet or optical cards, flash memory, or other type of media/machine-readable medium suitable for storing electronic instructions.

The techniques shown in the figures can be implemented using code and data stored and executed on one or more electronic devices (e.g., an end station, a network element). Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). Thus, the storage device of a given electronic device typically stores code and/or data for execution on the set of one or more processors of that electronic device. Of course, one or more parts of an embodiment may be implemented using different combinations of software, firmware, and/or hardware.

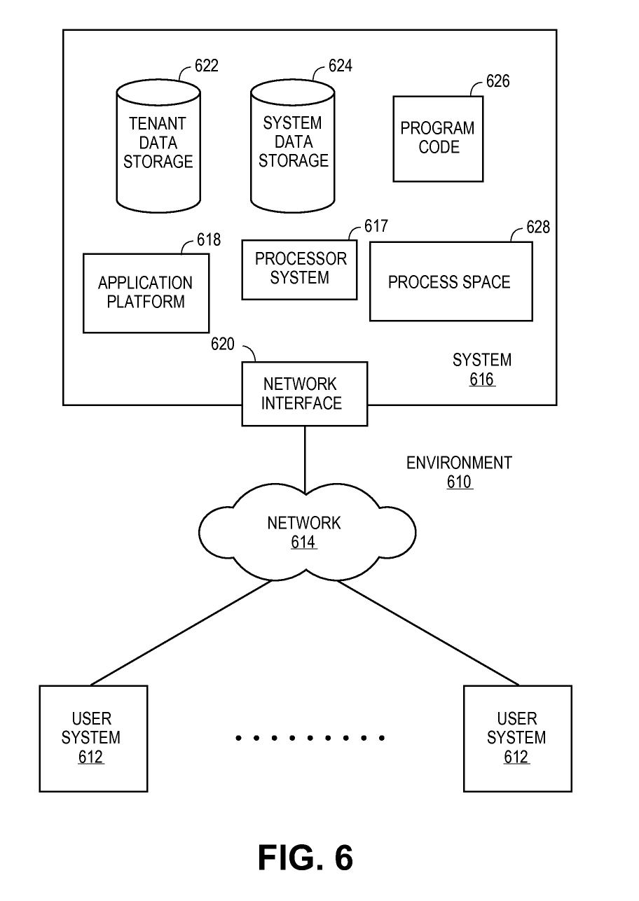

FIG. 6 illustrates a block diagram of an environment 610 wherein an on-demand database service might be used. Environment 610 may include user systems 612, network 614, system 616, processor system 617, application platform 618, network interface 620, tenant data storage 622, system data storage 624, program code 626, and process space 628. In other embodiments, environment 610 may not have all of the components listed and/or may have other elements instead of, or in addition to, those listed above.

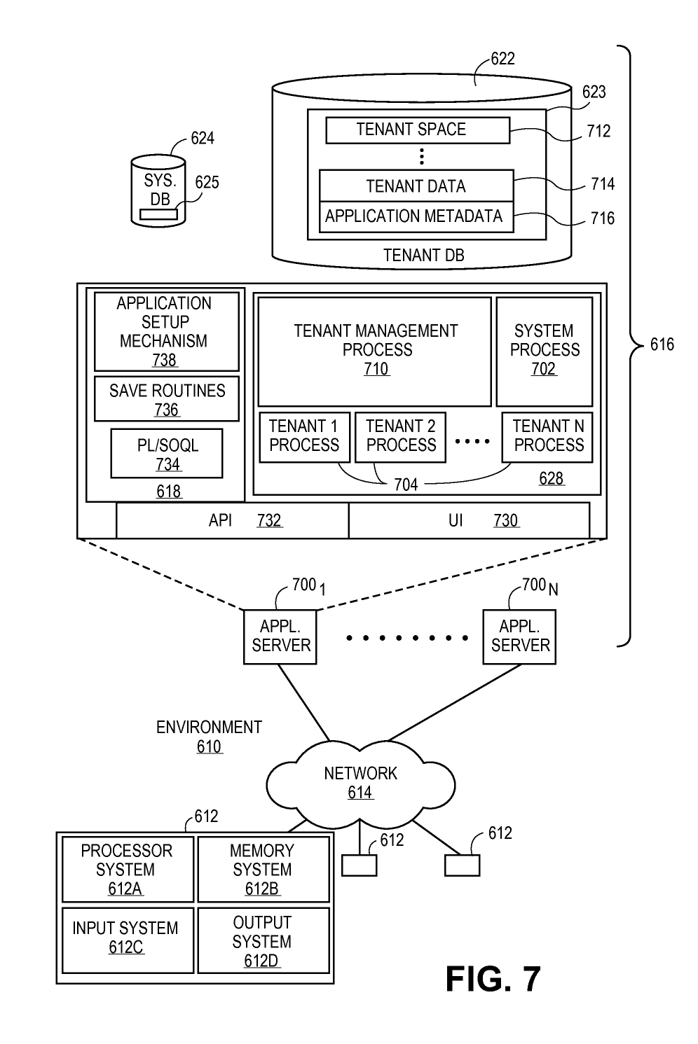

Environment 610 is an environment in which an on-demand database service exists. User system 612 may be any machine or system that is used by a user to access a database user system. For example, any of user systems 612 can be a handheld computing device, a mobile phone, a laptop computer, a work station, and/or a network of computing devices. As illustrated in herein FIG. 6 (and in more detail in FIG. 7) user systems 612 might interact via a network 614 with an on-demand database service, which is system 616.

An on-demand database service, such as system 616, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 616” and “system 616” will be used interchangeably herein. A database image may include one or more database objects. A relational database management system (RDMS) or the equivalent may execute storage and retrieval of information against the database object(s). Application platform 618 may be a framework that allows the applications of system 616 to run, such as the hardware and/or software, e.g., the operating system. In an embodiment, on-demand database service 616 may include an application platform 618 that enables creation, managing and executing one or more applications developed by the provider of the on-demand database service, users accessing the on-demand database service via user systems 612, or third party application developers accessing the on-demand database service via user systems 612.

The users of user systems 612 may differ in their respective capacities, and the capacity of a particular user system 612 might be entirely determined by permissions (permission levels) for the current user. For example, where a salesperson is using a particular user system 612 to interact with system 616, that user system has the capacities allotted to that salesperson. However, while an administrator is using that user system to interact with system 616, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 614 is any network or combination of networks of devices that communicate with one another. For example, network 614 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that one or more implementations might use are not so limited, although TCP/IP is a frequently implemented protocol.

User systems 612 might communicate with system 616 using TCP/IP and, at a higher network level, use other common Internet protocols to communicate, such as HTTP, FTP, AFS, WAP, etc. In an example where HTTP is used, user system 612 might include an HTTP client commonly referred to as a “browser” for sending and receiving HTTP messages to and from an HTTP server at system 616. Such an HTTP server might be implemented as the sole network interface between system 616 and network 614, but other techniques might be used as well or instead. In some implementations, the interface between system 616 and network 614 includes load sharing functionality, such as round-robin HTTP request distributors to balance loads and distribute incoming HTTP requests evenly over a plurality of servers. At least as for the users that are accessing that server, each of the plurality of servers has access to the MTS′ data; however, other alternative configurations may be used instead.

In one embodiment, system 616, shown in FIG. 6, implements a web-based customer relationship management (CRM) system. For example, in one embodiment, system 616 includes application servers configured to implement and execute CRM software applications as well as provide related data, code, forms, webpages and other information to and from user systems 612 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 616 implements applications other than, or in addition to, a CRM application. For example, system 616 may provide tenant access to multiple hosted (standard and custom) applications, including a CRM application. User (or third party developer) applications, which may or may not include CRM, may be supported by the application platform 618, which manages creation, storage of the applications into one or more database objects and executing of the applications in a virtual machine in the process space of the system 616.

One arrangement for elements of system 616 is shown in FIG. 6, including a network interface 620, application platform 618, tenant data storage 622 for tenant data 623, system data storage 624 for system data 625 accessible to system 616 and possibly multiple tenants, program code 626 for implementing various functions of system 616, and a process space 628 for executing MTS system processes and tenant-specific processes, such as running applications as part of an application hosting service. Additional processes that may execute on system 616 include database indexing processes.

Several elements in the system shown in FIG. 6 include conventional, well-known elements that are explained only briefly here. For example, each user system 612 could include a desktop personal computer, workstation, laptop, PDA, cell phone, or any wireless access protocol (WAP) enabled device or any other computing device capable of interfacing directly or indirectly to the Internet or other network connection. User system 612 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 612 to access, process and view information, pages and applications available to it from system 616 over network 614. Each user system 612 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 616 or other systems or servers. For example, the user interface device can be used to access data and applications hosted by system 616, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 612 and all of its components are operator configurable using applications, such as a browser, including computer code run using a central processing unit such as an Intel Pentium® processor or the like. Similarly, system 616 (and additional instances of an MTS, where more than one is present) and all of their components might be operator configurable using application(s) including computer code to run using a central processing unit such as processor system 617, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 616 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 616 is configured to provide webpages, forms, applications, data and media content to user (client) systems 612 to support the access by user systems 612 as tenants of system 616. As such, system 616 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 7 also illustrates environment 610. However, in FIG. 7 elements of system 616 and various interconnections in an embodiment are further illustrated. FIG. 7 shows that user system 612 may include processor system 612A, memory system 612B, input system 612C, and output system 612D. FIG. 7 shows network 614 and system 616. FIG. 7 also shows that system 616 may include tenant data storage 622, tenant data 623, system data storage 624, system data 625, User Interface (UI) 730, Application Program Interface (API) 732, PL/SOQL 734, save routines 736, application setup mechanism 738, applications servers 700₁-700_{N}, system process space 702, tenant process spaces 704, tenant management process space 710, tenant storage area 712, user storage 714, and application metadata 716. In other embodiments, environment 610 may not have the same elements as those listed above and/or may have other elements instead of, or in addition to, those listed above.

User system 612, network 614, system 616, tenant data storage 622, and system data storage 624 were discussed above in FIG. 6. Regarding user system 612, processor system 612A may be any combination of one or more processors. Memory system 612B may be any combination of one or more memory devices, short term, and/or long term memory. Input system 612C may be any combination of input devices, such as one or more keyboards, mice, trackballs, scanners, cameras, and/or interfaces to networks. Output system 612D may be any combination of output devices, such as one or more monitors, printers, and/or interfaces to networks. As shown by FIG. 7, system 616 may include a network interface 620 (of FIG. 6) implemented as a set of HTTP application servers 700, an application platform 618, tenant data storage 622, and system data storage 624. Also shown is system process space 702, including individual tenant process spaces 704 and a tenant management process space 710. Each application server 700 may be configured to tenant data storage 622 and the tenant data 623 therein, and system data storage 624 and the system data 625 therein to serve requests of user systems 612. The tenant data 623 might be divided into individual tenant storage areas 712, which can be either a physical arrangement and/or a logical arrangement of data. Within each tenant storage area 712, user storage 714 and application metadata 716 might be similarly allocated for each user. For example, a copy of a user's most recently used (MRU) items might be stored to user storage 714. Similarly, a copy of MRU items for an entire organization that is a tenant might be stored to tenant storage area 712. A UI 730 provides a user interface and an API 732 provides an application programmer interface to system 616 resident processes to users and/or developers at user systems 612. The tenant data and the system data may be stored in various databases, such as one or more Oracle™ databases.

Application platform 618 includes an application setup mechanism 738 that supports application developers' creation and management of applications, which may be saved as metadata into tenant data storage 622 by save routines 736 for execution by subscribers as one or more tenant process spaces 704 managed by tenant management process 710 for example. Invocations to such applications may be coded using PL/SOQL 734 that provides a programming language style interface extension to API 732. A detailed description of some PL/SOQL language embodiments is discussed in commonly owned U.S. Pat. No. 7,730,478 entitled, “Method and System for Allowing Access to Developed Applicants via a Multi-Tenant Database On-Demand Database Service”, issued Jun. 1, 2010 to Craig Weissman, which is incorporated in its entirety herein for all purposes. Invocations to applications may be detected by one or more system processes, which manage retrieving application metadata 716 for the subscriber making the invocation and executing the metadata as an application in a virtual machine.

Each application server 700 may be communicably coupled to database systems, e.g., having access to system data 625 and tenant data 623, via a different network connection. For example, one application server 700₁ might be coupled via the network 614 (e.g., the Internet), another application server 700_{N-1} might be coupled via a direct network link, and another application server 700_{N} might be coupled by yet a different network connection. Transfer Control Protocol and Internet Protocol (TCP/IP) are typical protocols for communicating between application servers 700 and the database system. However, it will be apparent to one skilled in the art that other transport protocols may be used to optimize the system depending on the network interconnect used.

In certain embodiments, each application server 700 is configured to handle requests for any user associated with any organization that is a tenant. Because it is desirable to be able to add and remove application servers from the server pool at any time for any reason, there is preferably no server affinity for a user and/or organization to a specific application server 700. In one embodiment, therefore, an interface system implementing a load balancing function (e.g., an F5 Big-IP load balancer) is communicably coupled between the application servers 700 and the user systems 612 to distribute requests to the application servers 700. In one embodiment, the load balancer uses a least connections algorithm to route user requests to the application servers 700. Other examples of load balancing algorithms, such as round robin and observed response time, also can be used. For example, in certain embodiments, three consecutive requests from the same user could hit three different application servers 700, and three requests from different users could hit the same application server 700. In this manner, system 616 is multi-tenant, wherein system 616 handles storage of, and access to, different objects, data and applications across disparate users and organizations.

As an example of storage, one tenant might be a company that employs a sales force where each salesperson uses system 616 to manage their sales process. Thus, a user might maintain contact data, leads data, customer follow-up data, performance data, goals and progress data, etc., all applicable to that user's personal sales process (e.g., in tenant data storage 622). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 616 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 616 might also maintain system level data usable by multiple tenants or other data. Such system level data might include industry reports, news, postings, and the like that are sharable among tenants.

In certain embodiments, user systems 612 (which may be client systems) communicate with application servers 700 to request and update system-level and tenant-level data from system 616 that may require sending one or more queries to tenant data storage 622 and/or system data storage 624. System 616 (e.g., an application server 700 in system 616) automatically generates one or more SQL statements (e.g., one or more SQL queries) that are designed to access the desired information. System data storage 624 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

Any of the above embodiments may be used alone or together with one another in any combination. Embodiments encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements. It is to be understood that the above description is intended to be illustrative, and not restrictive.

What is claimed is:

1. A method comprising:
developing at a product via a user-controlled cloud platform facilitated by a mechanism at a first computing device;
generating the product at the cloud platform; and
maintaining, in real-time, the product at the cloud platform via the mechanism at the first computing device.

2. The method of claim 1, wherein the generated product is deployed at a second computing device coupled to the first computing device over a network, wherein the first computing device includes a server computing device.

3. The method of claim 1, wherein the request for developing the product is placed, via a user interface, at the second computing device including a client computing device, the client computing device having desktop computing devices or mobile computing devices, wherein the request is placed by a user serving as a representative of an organization including one or more of a business, a government agency, an educational institution, a non-profit organization.

4. The method of claim 1, wherein the product comprises one or more of a website including a business website or a customer website, a software application including a business software application, and a database.

5. The method of claim 1, further comprising:
performing an edit to the product at the cloud platform, wherein performing includes one or more of making changes to contents of the product, upgrading current version of the product, reformatting or redesigning the product; and
continuing maintenance of the product once the error has been performed.

6. The method of claim 1, further comprising:
detecting an error with the cloud platform;
automatically resolving, via the mechanism, the error with the cloud platform; and
continuing maintenance of the product once the error has been performed.

7. The method of claim 1, wherein the network comprises one or more of a cloud-based network, a Local Area Network (LAN), a Wide Area Network (WAN), a Metropolitan Area Network (MAN), a Personal Area Network (PAN), an intranet, an extranet, or the Internet.

8. A system comprising:
a computing device having a memory to store instructions, and a processing device to execute the instructions, the computing device further having a mechanism to:
develop at a product via a user-controlled cloud platform facilitated by a mechanism at a first computing device;
generate the product at the cloud platform; and
maintain, in real-time, the product at the cloud platform via the mechanism at the first computing device.

9. The system of claim 8, wherein the generated product is deployed at a second computing device coupled to the first computing device over a network, wherein the first computing device includes a server computing device.

10. The system of claim 8, wherein the request for developing the product is placed, via a user interface, at the second computing device including a client computing device, the client computing device having desktop computing devices or mobile computing devices, wherein the request is placed by a user serving as a representative of an organization including one or more of a business, a government agency, an educational institution, a non-profit organization.

11. The system of claim 8, wherein the product comprises one or more of a website including a business website or a customer website, a software application including a business software application, and a database.

12. The system of claim 8, wherein the mechanism is further to:
perform an edit to the product at the cloud platform, wherein performing includes one or more of making changes to contents of the product, upgrading current version of the product, reformatting or redesigning the product; and
continue maintenance of the product once the error has been performed.

13. The system of claim 8, wherein the mechanism is further to:
detect an error with the cloud platform;
automatically resolve, via the mechanism, the error with the cloud platform; and
continue maintenance of the product once the error has been performed.

14. The system of claim 8, wherein the network comprises one or more of a cloud-based network, a Local Area Network (LAN), a Wide Area Network (WAN), a Metropolitan Area Network (MAN), a Personal Area Network (PAN), an intranet, an extranet, or the Internet.

15. A machine-readable medium having stored thereon instructions which, when executed by a machine, cause the machine to:
develop at a product via a user-controlled cloud platform facilitated by a mechanism at a first computing device;
generate the product at the cloud platform; and
maintain, in real-time, the product at the cloud platform via the mechanism at the first computing device.

16. The machine-readable medium of claim 15, wherein the generated product is deployed at a second computing device coupled to the first computing device over a network, wherein the first computing device includes a server computing device.

17. The machine-readable medium of claim 15, wherein the request for developing the product is placed, via a user interface, at the second computing device including a client computing device, the client computing device having desktop computing devices or mobile computing devices, wherein the request is placed by a user serving as a representative of an organization including one or more of a business, a government agency, an educational institution, a non-profit organization.

18. The machine-readable medium of claim 15, wherein the product comprises one or more of a website including a business website or a customer website, a software application including a business software application, and a database.

19. The machine-readable medium of claim 15, wherein the machine is further caused to:
perform an edit to the product at the cloud platform, wherein performing includes one or more of making changes to contents of the product, upgrading current version of the product, reformatting or redesigning the product; and
continue maintenance of the product once the error has been performed.

20. The machine-readable medium of claim 15, wherein the machine is further caused to:
detect an error with the cloud platform;
automatically resolve, via the mechanism, the error with the cloud platform; and
continue maintenance of the product once the error has been performed.
